(19) United States
(12) Patent Application Publication
(10) Pub. No.: US 2007/0226689 A1
(43) Pub. Date: Sep. 27, 2007

(54) Mechanism for selectively allowing certain components in a group of components to be associated with a target component

(76) Inventor: Kevin T. Schmidt, Pasadena, CA (US)

Correspondence Address: HICKMAN PALERMO TRUONG & BECKER, LLP;AND SUN MICROSYSTEMS, INC., 2055 GATEWAY PLACE, SUITE 550, SAN JOSE, CA, 95110-1089, US

(21) Appl. No.: 11/387,916

(22) Filed: Mar. 22, 2006

(51) Int. Cl. G06F 9/44

(52) U.S. Cl. 717/120

(57) ABSTRACT

A mechanism is disclosed for selectively allowing certain components in a group of components to be associated with a target component. With this mechanism, it is possible for a user to select a group of candidate components, and to drop that group of candidate components into a target component. Thereafter, the mechanism iterates through the group of candidate components, and for each candidate component that is compatible with the target component, that candidate component is allowed to be associated with the target component. For each candidate component that is not compatible with the target component, that candidate component is disallowed from being associated with the target component. Some of the candidate components may be associated with the target component while others are not. This mechanism allows a user to associate a group of candidate components with a target component without knowing which candidate components are compatible with the target component.

### BACKGROUND

Many computer programs allow a user to use a graphical user interface (GUI) to map or associate a certain component with another component. For example, using a GUI, a user can select, drag, and drop a first file directory into a second file directory. Doing so remaps the first file directory so that it is now in the second file directory. Similarly, in a business application integration context, a user can select, drag, and drop an application component icon into a system icon. Doing so associates the application component with the system so that the application is specified as being deployed on that system.

In order to map or associate (hereinafter, associate) a first component with a second component, the components need to be compatible with each other. By compatible, it is meant that it has to make logical and operational sense to associate one component with the other. If the components are not compatible, then the association should not be performed. Currently, in most implementations, it is up to the user to know which components are compatible with which other components. Thus, it is up to the user to select the proper components, and to drop them into the proper components. Unfortunately, in many contexts, such as the business application integration context, it may be difficult for a user to know exactly which components are compatible with which other components. For example, the user may be a non-technical person who is not familiar with all of the low level details of the components, or the components and their inter-relationships may be too numerous and complex for any user to fully grasp. If a user is not intimately familiar with which components are compatible with which other components, then that user may mistakenly try to associate a component with another component with which that component is not compatible.

When a user tries to associate a component with another component that is not compatible with the first component, one of two things may happen. First, the underlying program may allow the association to take place. If this occurs, then the erroneous association may cause serious errors down the road when that program or another program tries to enforce the association. This type of error can be quite difficult to find and debug. The other thing that may happen is that the underlying program detects the incompatibility, and sends a warning message to the user. While this prevents the association from being formed, and hence, prevents problems down the road, it is a disruption to the user. If the user has to associate a large number of components with a large number of other components, this disruption multiplied over many components can cause significant frustration for the user and impose significant delay in the work process. Thus, for at least these reasons, requiring a user to know which components are compatible with which other components, and requiring the user to use that knowledge in making the associations, is problematic.

### SUMMARY

To overcome the shortcomings of the current approach, one embodiment of the present invention provides a mechanism for selectively allowing certain components in a group of components to be associated with a target component. With this mechanism, it is possible for a user to select a group of candidate components, and to drop that entire group of candidate components into a target component. When the mechanism receives an indication that the user is attempting to associate the group of candidate components with the target component, the mechanism iterates through the group of candidate components and determines whether each candidate component is compatible with the target component. For each candidate component that is compatible with the target component, that candidate component is allowed to be associated with the target component. For each candidate component that is not compatible with the target component, that candidate component is disallowed from being associated with the target component. At the end of this process, some of the candidate components may be associated with the target component while other candidate components are not.

Notice that this approach requires little knowledge on the part of the user. All the user has to do is to select and group the candidate components, and to drop them into the target component. After that, it is the mechanism that automatically determines which candidate components are compatible with, and hence, can be associated with the target component, and which candidate components are not compatible with, and hence, cannot be associated with the target component. Thus, this mechanism reduces the burden on the user to know the low level details of each of the components. This mechanism also allows a user to quickly and easily associate a potentially large number of candidate components with a target component. Overall, this mechanism represents a significant improvement over the prior art.

### BRIEF DESCRIPTION OF THE DRAWINGS

FIG. 1 is a functional block diagram of a system in which one embodiment of the present invention may be implemented.

FIG. 2 shows a sample graphical user interface display, in accordance with one embodiment of the present invention.

FIG. 3 is an operational flow diagram showing the operation of one embodiment of the present invention.

FIG. 4 is a block diagram of a general purpose computer system in which one embodiment of the present invention may be implemented.

### DETAILED DESCRIPTION OF EMBODIMENT(S)

### Definitions

Component—any logical or physical entity, construct, or structure.

Associate—to form a relationship of any kind between two or more components.

### Overview

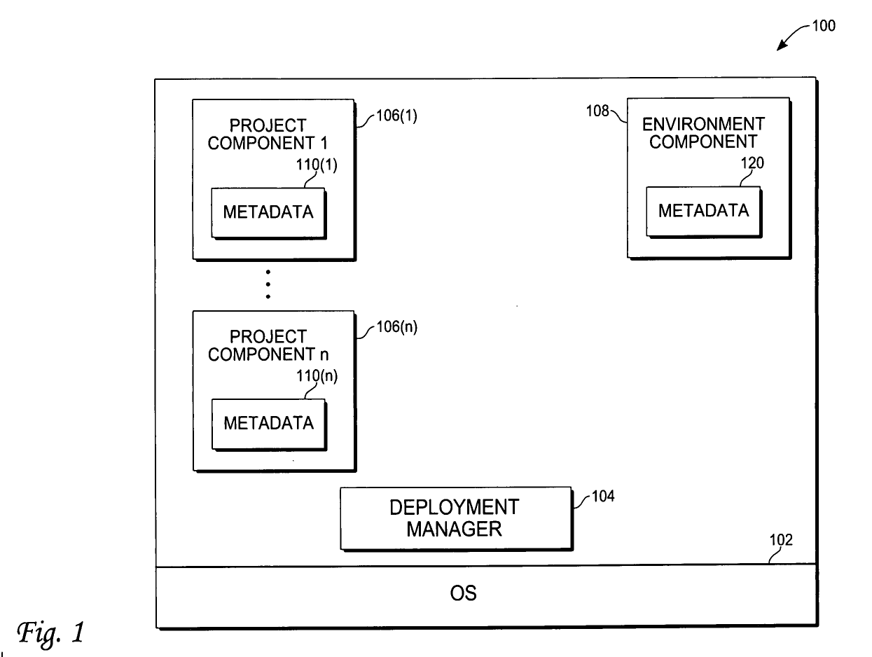

With reference to FIG. 1, there is shown a fuctional block diagram of a system 100 in which one embodiment of the present invention may be implemented. In the following discussion, an embodiment of the invention will be described in the context of a business application integration system in which project components are deployed onto certain environments. However, it should be noted that this is for illustrative purposes only. The present invention is not limited to being implemented in such a context but rather may be applied generally to any context in which it is desirable to associate one component with another component. All such applications are within the scope of the present invention.

As shown in FIG. 1, the system 100 comprises an operating system (OS) 102 and a deployment manager 104. For purposes of the present invention, the OS 102 may be any type of operating system, including but not limited to Solaris, Unix, Windows, MacOS, Linux, etc. The OS 102 provides all of the low level functionality that is relied upon by all of the other components in the system. This functionality may include receiving user input and rendering output to a user.

The deployment manager 104 executes on top of the OS 102. In operation, the deployment manager 104 manages a plurality n (where n is any integer greater than or equal to 2) of project components 106 and one or more environment components 108 (for the sake of simplicity, only one environment component is shown). In this context, a project component 106 represents a set of application code that can be deployed, and an environment component represents a system on which a project component may be deployed. In system 100, it is the deployment manager 104 that manages the association between the project components 106 and the environment component 108. By making an association between a project component 106 and the environment component 108, the deployment manger 104 is in effect specifying that that project component 106 is to be deployed on that environment component. As will be discussed further in a later section, in making associations between the project components 106 and the environment component 108, the deployment manager implements the selective association methodology of one embodiment of the present invention.

To enable the deployment manager 104 to carry out the selective association methodology, each component has a set of metadata associated therewith. As shown in FIG. 1, project component 106(1) has metadata 110(1), project component 106(n) has metadata 110(n), and environment component 108 has metadata 120. This metadata is used by the deployment manager 104 to determine whether a particular project component 106 is compatible with a particular environment component 108. In one embodiment, a first component is compatible with another component if it makes logical and operational sense to associate the first component with the other component. Put another way, a first component is compatible with another component if the two components can properly interact and operate together. For example, if the project component 106(1) is a database-related component and the environment component 108 is a database management system, then the two components may be compatible. On the other hand, if the project component 106(1) is a database-related component and the environment component 108 is a web server, then the two components may not be compatible. Based on the metadata, the deployment manager 104 determines compatibility. If two components are compatible, then an association between the components may be allowed. If the two components are not compatible, then any association between the components will be disallowed.

The metadata associated with a component specifies certain information about that component. In one embodiment, the metadata associated with a component specifies a component type for that component. For example, metadata 110(1) may specify a component type for project component 106(1), and metadata 120 may specify a component type for environment component 108. There may be many different possible component types. For example, each project component 106 may be one of many different possible component types, and the environment component 108 may be one of many different possible component types. Given the component type for a project component 106, and the component type for the environment component 108, it is possible to implement some logic to determine whether the two components are compatible with each other.

In an alternative embodiment, the metadata specified for a project component 106 is different from the metadata specified for the environment component 108. Specifically, instead of specifying a component type for a project component 106, the metadata 110 for a project component 106 would specify a list of all of the component types with which that project component 106 is compatible. In such an embodiment, the metadata 120 for the environment component 108 would specify a component type for the environment component 108. Given this information, it can be determined whether the environment component 108 is of a component type that is compatible with the project component 106.

In yet another alternative embodiment, the metadata 120 for the environment component 108 would specify a list of all of the component types with which that environment component 108 is compatible. In such an embodiment, the metadata 110 for a project component 106 would specify a component type for that project component 106. Given this information, it can be determined whether the project component 106 is of a component type that is compatible with the environment component 108.

Depending upon the content of the metadata 110, 120, the methodology for determining compatibility will differ. This will be elaborated upon in a later section.

### User Interface Display

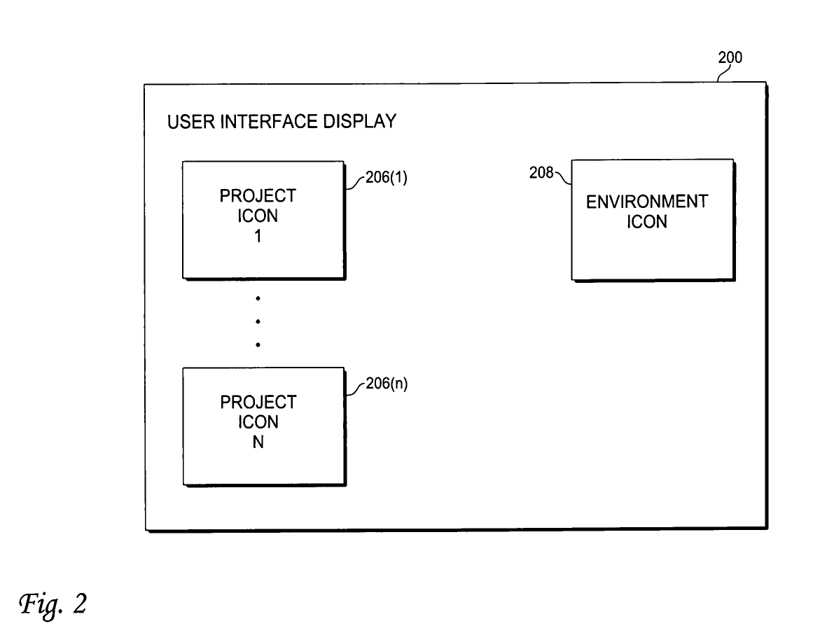

In one embodiment, the deployment manager 104 allows a user to specify which project components 106 are to be associated with which environment component 108. To enable the user to make such specifications, the deployment manager 104 generates a GUI display. A sample display is shown in FIG. 2, wherein the display 200 includes an icon for each of the components shown in FIG. 1. Specifically, project icon 206(1) represents project component 106(1), project icon 206(n) represents project component 106(n), and environment icon 208 represents environment component 108. Given this GUI display 200, a user can use one or more user interface devices to specify to the deployment manager 104 the associations that the user wishes to form between the project components 106 and the environment component 108.

### Sample Operation

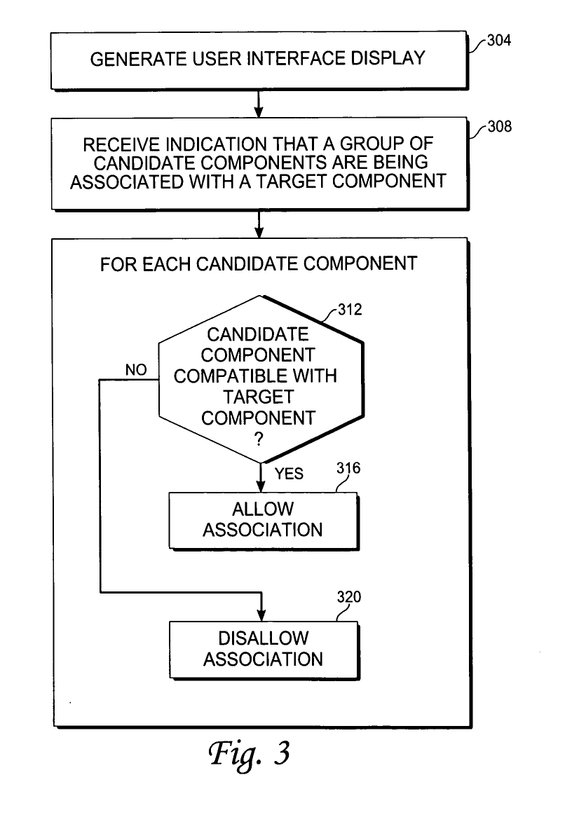

To illustrate how the deployment manager 104 may operate in accordance with one embodiment of the present invention, reference will now be made to an example. In the following discussion, reference will be made to the functional block diagrams of FIGS. 1 and 2, and the operational flow diagram of FIG. 3.

Initially, the deployment manager 104 generates (block 304) a graphical user interface display, such as the display 200 shown in FIG. 2. This display includes one or more icons, each of which represents one of the components shown in FIG. 1. If so desired, the display 200 may include an icon for each of the components shown in FIG. 1. Alternatively, the display 200 may include fewer icons than there are components in FIG. 1. In the current example, it will be assumed that the display 200 includes an icon for each of the components in FIG. 1. Thus, there is a project icon 206(1) that represents project component 106(1), a project icon 206(n) that represents project component 106(n), and an environment icon 208 that represents environment component 108. After the display 200 is generated by the deployment manager 104, it is passed on to the OS 102, which renders the display to a user.

Once the display 200 is rendered to the user, the user can use one or more user interface devices (e.g. a mouse, a trackball, a stylus, a touch pad, a keyboard, etc.) to specify associations between the project icons 206 and the environment icon 208. In one embodiment, the user is allowed to associate a group of two or more project icons 206 with the environment icon 208. To do so, the user initially selects a desired group of project icons 206. In a Windows setting, for example, this may be done by clicking on multiple project icons 206 while holding down the “ctrl” key on the keyboard. Doing so selects each of the clicked project icons 206 and groups them together. For the sake of example, it will be assumed that the user selects all of the project icons 206; thus, all of the project icons 206 are included in the group. After selecting the group of project icons 206, the user may, using a user interface device such as a mouse, drag the group of project icons 206 over the environment icon 208, and drop them into the environment icon 208. By doing so, the user is indicating that he/she wishes to associate all of the project icons 206 in the group with the environment icon 208.

Upon detecting these user interface events, the OS 102 passes them on to the deployment manager 104 to notify the deployment manager 104 of the user input. Upon receiving (block 308) these notifications, the deployment manager 104 interprets them as an indication that the user wishes to associate the group of project icons 206 (and hence, the group of project components 106 represented by the project icons 206) with the environment icon 208 (and hence, the environment component 108 represented by the environment icon 208). In one embodiment, the deployment manager 104 does not automatically make these associations. Rather, before associating any project component 106 with the environment component 108, the deployment manager 104 first checks to make sure that that project component 106 is compatible with the environment component 108. Because the project components 106 have not yet been verified as being compatible with the environment component 108, they are viewed for now as being just candidate components, and the environment component 108 is viewed as the target component.

To determine whether the requested associations should be allowed, the deployment manager 104 iterates through each of the project components 106 in the group. For each project component 106 in the group, the deployment manager 104 determines (block 312) whether that project component 106 is compatible with the environment component 108. In one embodiment, the deployment manager 104 does so by accessing the metadata 110 associated with the project component 106, accessing the metadata 120 associated with the environment component 108, and processing the two sets of metadata to determine whether the two components are compatible. The manner in which this processing is carried out will depend upon the contents of the metadata, and will be elaborated upon in a later section.

If the deployment manager 104 determines that the project component 106 is compatible with the environment component 108, then the requested association between the project component 106 and the environment component 108 is allowed (block 316). Otherwise, the requested association is disallowed (block 320). In one embodiment, if the requested association is disallowed, the deployment manager 104 updates the user interface display 200 to show the project icon 206 associated with that project component 106 returning to its original position. For example, if the requested association between the project component 106(1) and the environment component 108 is disallowed, then the deployment manager 104 will update the user interface display 200 to show the project icon 206(1) associated with the project component 106(1) moving or “flying” across the display from a location just over the environment icon 208 (where the user had dragged the project icon 206(1)) back to its original location. This provides to the user a visual indication that the requested association between that project icon 206(1) (and its associated project component 106(1)) and the environment icon 208 (and its associated environment component 108) was disallowed.

The deployment manager 104 performs the above determination for each project component 106 in the group. By the end of this process, some, all, or none of the project components 106 in the group may be associated with the environment component 108. A significant point to note is that the deployment manager 104 need not allow or disallow the requested associations as an entire group. Rather, the deployment manager 104 may allow (based on compatibility) some of the project components 106 in the group to be associated with the environment component 108, while disallowing others. Thus, the deployment manager 104 is able to selectively associate zero or more project components 106 in the group with the environment component 108.

Notice that this approach requires little knowledge on the part of the user. All the user has to do is to select and group the project icons 206, and to drop them into the environment icon 208. After that, it is the deployment manager 104 that automatically determines which project components 106 are compatible with, and hence, can be associated with the environment component 108, and which project components 106 are not compatible with, and hence, cannot be associated with the environment component 108. By doing this, the deployment manager 104 reduces the burden on the user to know the low level details of each of the components. The deployment manager 104 also allows a user to quickly and easily associate a potentially large number of project components 106 with the environment component 108. Overall, the deployment manager 104 and its selective association capability represents a significant improvement over the prior art.

### Determining Compatibility

As noted above, depending upon the content of the metadata 110, 120, the methodology for determining compatibility between components will differ. The following discussion addresses three possibilities (note: these possibilities are meant to be exemplary, not exhaustive).

First, suppose that the metadata 110 associated with a project component 106 specifies a component type for that project component 106, and the metadata 120 associated with the environment component 108 specifies a component type for the environment component 108. In such a scenario, the deployment manager 104 determines compatibility based upon the two component types. For example, the deployment manager 104 may embody some logic that knows which component types are compatible with which component types. Alternatively, the deployment manager 104 may consult a data repository (e.g. table, database, etc.) that specifies which component types are compatible with which component types. Using this repository, the deployment manager 104 can determine whether the component type of the project component 106 is compatible with the component type of the environment component 108.

Suppose instead that the metadata 110 associated with a project component 106 specifies a list of all of the component types with which that project component 106 is compatible, and that the metadata 120 associated with the environment component 108 specifies a component type for the environment component 108. In this scenario, the deployment manager 104 determines compatibility by determining whether the component type for the environment component 108 is one of the component types listed in the metadata 110 associated with the project component 106. If so, then the two components are compatible.

As a further possibility, suppose that the metadata 120 associated with an environment component 108 specifies a list of all of the component types with which that environment component 108 is compatible, and that the metadata 110 associated with a project component 106 specifies a component type for that project component 106. In such a scenario, the deployment manager 104 determines compatibility by determining whether the component type for the project component 106 is one of the component types listed in the metadata 120 associated with the environment component 108. If so, then the two components are compatible.

### Hardware Overview

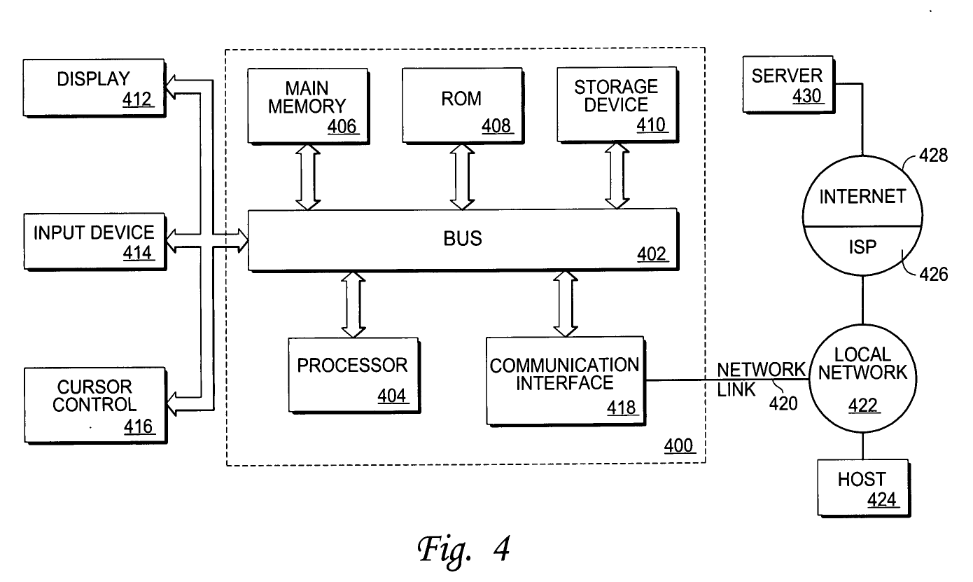

In one embodiment, the deployment manager 104 and the OS 102 may take the form of sets of instructions that are executed by one or more processors. If they take the form of sets of instructions, FIG. 4 shows a block diagram of a computer system 400 upon which these sets of instructions may be executed. Computer system 400 includes a bus 402 for facilitating information exchange, and one or more processors 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions by processor 404. Computer system 400 may further include a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412 for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

In computer system 400, bus 402 may be any mechanism and/or medium that enables information, signals, data, etc., to be exchanged between the various components. For example, bus 402 may be a set of conductors that carries electrical signals. Bus 402 may also be a wireless medium (e.g. air) that carries wireless signals between one or more of the components. Bus 402 may further be a network connection that connects one or more of the components. Any mechanism and/or medium that enables information, signals, data, etc., to be exchanged between the various components may be used as bus 402.

Bus 402 may also be a combination of these mechanisms/media. For example, processor 404 may communicate with storage device 410 wirelessly. In such a case, the bus 402, from the standpoint of processor 404 and storage device 410, would be a wireless medium, such as air. Further, processor 404 may communicate with ROM 408 capacitively. Further, processor 404 may communicate with main memory 406 via a network connection. In this case, the bus 402 would be the network connection. Further, processor 404 may communicate with display 412 via a set of conductors. In this instance, the bus 402 would be the set of conductors. Thus, depending upon how the various components communicate with each other, bus 402 may take on different forms. Bus 402, as shown in FIG. 4, functionally represents all of the mechanisms and/or media that enable information, signals, data, etc., to be exchanged between the various components.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, DVD, or any other optical storage medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

At this point, it should be noted that although the invention has been described with reference to a specific embodiment, it should not be construed to be so limited. Various modifications may be made by those of ordinary skill in the art with the benefit of this disclosure without departing from the spirit of the invention. Thus, the invention should not be limited by the specific embodiments used to illustrate it but only by the scope of the issued claims and the equivalents thereof.

What is claimed is:

1. A machine implemented method, comprising:
receiving an indication that a user is attempting to associate a group of two or more candidate components with a target component;
for each candidate component in the group of candidate components:
determining whether that candidate component is compatible with the target component;
in response to a determination that that candidate component is compatible with the target component, allowing that candidate component to be associated with the target component; and
in response to a determination that that candidate component is not compatible with the target component, disallowing that candidate component from being associated with the target component.

2. The method of claim 1, wherein one or more of the candidate components in the group of candidate components may be allowed to be associated with the target component, while one or more other candidate components in the group of candidate components may be disallowed from being associated with the target component.

3. The method of claim 2, wherein determining comprises:
accessing a particular set of metadata associated with that candidate component;
accessing a target set of metadata associated with the target component; and
processing the particular set of metadata and the target set of metadata to determine whether that candidate component is compatible with the target component.

4. The method of claim 3, wherein the particular set of metadata specifies a component type for that candidate component, wherein the target set of metadata specifies a component type for the target component, and wherein processing comprises:
determining whether the component type for that candidate component is compatible with the component type for the target component.

5. The method of claim 3, wherein the particular set of metadata specifies one or more component types with which that candidate component is compatible, wherein the target set of metadata specifies a component type for the target component, and wherein processing comprises:
determining whether the component type for the target component is one of the component types with which that candidate component is compatible.

6. The method of claim 3, wherein the particular set of metadata specifies a component type for that candidate component, wherein the target set of metadata specifies one or more component types with which the target component is compatible, and wherein processing comprises:
determining whether the component type for that candidate component is one of the component types with which the target component is compatible.

7. The method of claim 2, further comprising:
generating a user interface display that includes a plurality of candidate icons and a target icon, wherein each of the candidate icons represents one of the candidate components in the group of candidate components, and wherein the target icon represents the target component.

8. The method of claim 7, wherein receiving an indication that a user is attempting to associate the group of two or more candidate components with the target component comprises:
receiving one or more indications that the user has selected each candidate icon in the plurality of candidate icons to be included in a group of candidate icons; and
receiving an indication that the user, using a user interface device, has dragged the group of candidate icons over the target icon, and has dropped the group of candidate icons into the target icon.

9. The method of claim 8, wherein disallowing that candidate component from being associated with the target component comprises:
causing a particular candidate icon that represents that candidate component to return to an original location in the user interface display from which the particular candidate icon was dragged.

10. The method of claim 9, wherein causing the particular candidate icon to return to the original location comprises:
causing the particular candidate icon to move across the user interface display from a location at which the target icon is situated to the original location.

11. A machine readable medium comprising one or more sets of instructions which, when executed by one or more processors, cause the one or more processors to perform the operations of:
receiving an indication that a user is attempting to associate a group of two or more candidate components with a target component;
for each candidate component in the group of candidate components:
determining whether that candidate component is compatible with the target component;
in response to a determination that that candidate component is compatible with the target component, allowing that candidate component to be associated with the target component; and
in response to a determination that that candidate component is not compatible with the target component, disallowing that candidate component from being associated with the target component.

12. The machine readable medium of claim 11, wherein one or more of the candidate components in the group of candidate components may be allowed to be associated with the target component, while one or more other candidate components in the group of candidate components may be disallowed from being associated with the target component.

13. The machine readable medium of claim 12, wherein determining comprises:
accessing a particular set of metadata associated with that candidate component;
accessing a target set of metadata associated with the target component; and
processing the particular set of metadata and the target set of metadata to determine whether that candidate component is compatible with the target component.

14. The machine readable medium of claim 13, wherein the particular set of metadata specifies a component type for that candidate component, wherein the target set of metadata specifies a component type for the target component, and wherein processing comprises:
determining whether the component type for that candidate component is compatible with the component type for the target component.

15. The machine readable medium of claim 13, wherein the particular set of metadata specifies one or more component types with which that candidate component is compatible, wherein the target set of metadata specifies a component type for the target component, and wherein processing comprises:
determining whether the component type for the target component is one of the component types with which that candidate component is compatible.

16. The machine readable medium of claim 13, wherein the particular set of metadata specifies a component type for that candidate component, wherein the target set of metadata specifies one or more component types with which the target component is compatible, and wherein processing comprises:
determining whether the component type for that candidate component is one of the component types with which the target component is compatible.

17. The machine readable medium of claim 12, further comprising one or more sets of instructions for causing the one or more processors to perform the operations of:
generating a user interface display that includes a plurality of candidate icons and a target icon, wherein each of the candidate icons represents one of the candidate components in the group of candidate components, and wherein the target icon represents the target component.

18. The machine readable medium of claim 17, wherein receiving an indication that a user is attempting to associate the group of two or more candidate components with the target component comprises:
receiving one or more indications that the user has selected each candidate icon in the plurality of candidate icons to be included in a group of candidate icons; and
receiving an indication that the user, using a user interface device, has dragged the group of candidate icons over the target icon, and has dropped the group of candidate icons into the target icon.

19. The machine readable medium of claim 18, wherein disallowing that candidate component from being associated with the target component comprises:
causing a particular candidate icon that represents that candidate component to return to an original location in the user interface display from which the particular candidate icon was dragged.

20. The machine readable medium of claim 19, wherein causing the particular candidate icon to return to the original location comprises:
causing the particular candidate icon to move across the user interface display from a location at which the target icon is situated to the original location.
